(19) United States
(12) Patent Application Publication
(10) Pub. No.: US 2016/0076222 A1
(43) Pub. Date: Mar. 17, 2016

(54) System and Method for Optimizing a Work Implement Path

(71) Applicant: Caterpillar Inc., Peoria, IL (US)

(72) Inventors: Michael Taylor, Swissvale, PA (US); Mo Wei, Dunlap, IL (US); Thandava K. Edara, Peoria, IL (US)

(73) Assignee: CATERPILLAR INC., Peoria, IL (US)

(21) Appl. No.: 14/484,548

(22) Filed: Sep. 12, 2014

(51) Int. Cl. E02F 9/20; G05D 3/00

(52) U.S. Cl. CPC E02F 9/2025; G05D 3/00

(57) ABSTRACT

A system for determining an optimized cut location for a work implement includes a position sensor and a controller. The controller is configured to determine the position of a work surface and determine an initial cut location along a path based upon an initial target profile and the initial target profile has an initial cut length longer than an evaluation cut length. The controller is also configured to determine a plurality of potential cut locations along the path, determine a volume of material to be moved for each of the plurality of potential cut locations with the volume of material to be moved being based upon the loading profile, the evaluation cut length, and the position of the work surface. The controller is configured to select that optimized cut location from one of the plurality of potential cut locations for which the volume of material exceeds the material volume threshold.

### TECHNICAL FIELD

This disclosure relates generally to controlling a machine and, more particularly, to a system and method for planning a path of a work implement to optimize an operating parameter related to a material moving operation.

### BACKGROUND

Machines such as dozers, motor graders, wheel loaders, etc., are used to perform a variety of tasks. For example, these machines may be used to move material at a work site. The machines may operate in an autonomous or semi-autonomous manner to perform these tasks in response to commands generated as part of a work plan for the machines. The machines may receive instructions in accordance with the work plan to perform operations including digging, loosening, carrying, etc., different materials at the work site such as those related to mining, earthmoving and other industrial activities.

Autonomously operated machines may remain consistently productive without regard to a human operator or environmental conditions. In addition, autonomous systems may permit operation in environments that are unsuitable or undesirable for a human operator. Autonomous or semi-autonomous systems may also compensate for inexperienced human operators as well as inefficiencies associated with repetitive tasks.

Movement of the machines and their associated work implements are often developed by a planning system or module. A plurality of variables may affect the planning system and impact the efficiency of the machine operation. It is often desirable to ensure that the machines perform the material movement operations such that the materials are moved in an efficient manner. For example, it may be desirable to ensure that the locations at which the machines begin to alter the work surface, and/or the profiles along which the machines alter the work surface, are chosen such that the machines function efficiently.

PCT Patent Publication No. 2008/0118027 discloses a method of contour shaping by a machine equipped with a cutting implement. The method includes providing a desired topographical plan, measuring the real time position of at least one of the machine and the cutting implement, generating instructions to move the cutting implement, plotting a transitional path from the real time position of the machine or the cutting implement to a point on the desired topographical plan, and using the transitional path and the real time position of the machine or the cutting implement to generate the instructions to move the cutting implement.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, a system for determining an optimized cut location for a work implement of a machine includes a position sensor for generating position signals indicative of a position of a work surface, and a controller. The controller is configured to store a loading profile, store a material volume threshold, store an evaluation cut length, receive position signals from the position sensor, and determine the position of the work surface based upon the position signals. The controller is further configured to determine an initial cut location along the path based upon an initial target profile and the initial target profile has an initial cut length longer than the evaluation cut length. The controller is also configured to determine a plurality of potential cut locations along the path, determine a volume of material to be moved for each of the plurality of potential cut locations with the volume of material to be moved being based upon the loading profile, the evaluation cut length, and the position of the work surface, and select the optimized cut location from one of the plurality of potential cut locations for which the volume of material exceeds the material volume threshold.

In another aspect, a controller-implemented method for determining an optimized cut location for a work implement of a machine includes storing a loading profile, storing a material volume threshold, storing an evaluation cut length, receiving position signals from a position sensor, and determining a position of the work surface based upon the position signals. The method also includes determining an initial cut location along the path based upon an initial target profile and the initial target profile has an initial cut length longer than the evaluation length. The method further includes determining a plurality of potential cut locations along the path, determining a volume of material to be moved for each of the plurality of potential cut locations with the volume of material to be moved being based upon the loading profile, the evaluation cut length, and the position of the work surface, and selecting the optimized cut location from one of the plurality of potential cut locations for which the volume of material exceeds the material volume threshold.

In still another aspect a machine includes a prime mover, a work implement for engaging a work surface along a path, a position sensor for generating position signals indicative of a position of the work surface, and a controller. The controller is configured to store a loading profile, store a material volume threshold, store an evaluation cut length, receive position signals from the position sensor, and determine the position of the work surface based upon the position signals. The controller is further configured to determine an initial cut location along the path based upon an initial target profile and the initial target profile has an initial cut length longer than the evaluation cut length. The controller is also configured to determine a plurality of potential cut locations along the path, determine a volume of material to be moved for each of the plurality of potential cut locations with the volume of material to be moved being based upon the loading profile, the evaluation cut length, and the position of the work surface, and select the optimized cut location from one of the plurality of potential cut locations for which the volume of material exceeds the material volume threshold.

### BRIEF DESCRIPTION OF THE DRAWINGS

FIG. 1 depicts a schematic view of a work site at which a machine incorporating the principles disclosed herein may be used;

FIG. 2 depicts a diagrammatic illustration of a machine in accordance with the disclosure;

FIG. 3 depicts a cross-section of a portion of a work site depicting various aspects of a material moving plan;

FIG. 4 depicts a diagrammatic cross-section of a portion of a work site depicting a potential target profile; and

FIG. 5 depicts a cross-section of a portion of a work site depicting an aspect of a first cut optimization process in accordance with the disclosure;

FIG. 6 depicts a cross-section of a portion of a work site depicting an aspect of a second cut optimization process in accordance with the disclosure;

FIG. 7 depicts a cross-section of a portion of a work site depicting an aspect of a third cut optimization process in accordance with the disclosure; and

FIG. 8 depicts a flowchart illustrating the cut optimization process in accordance with the disclosure.

### DETAILED DESCRIPTION

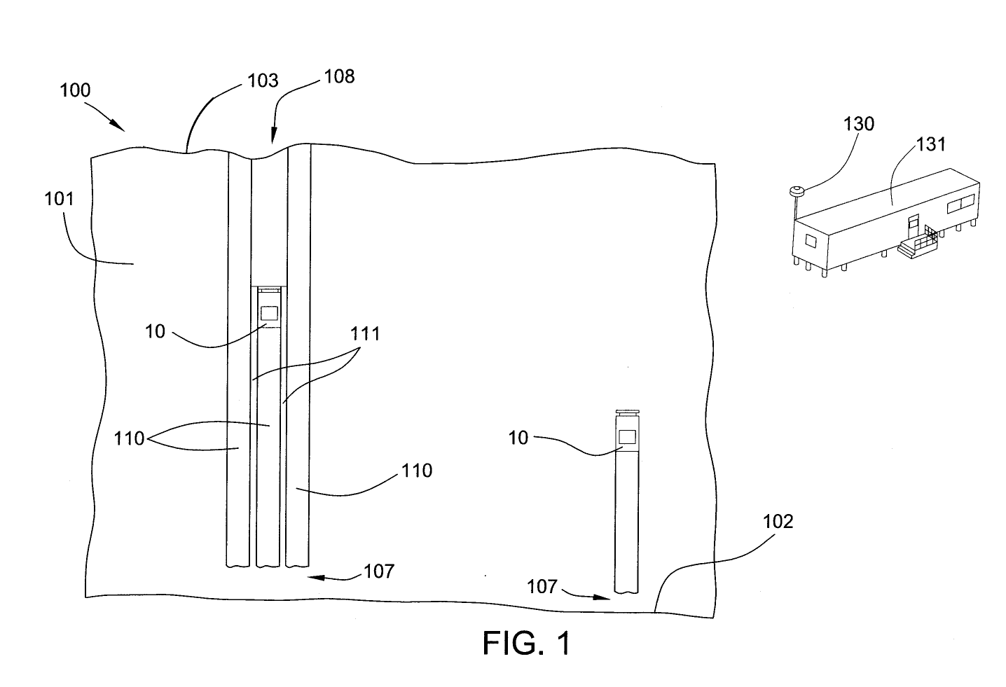

FIG. 1 depicts a diagrammatic illustration of a work site 100 at which one or more machines 10 may operate in an autonomous, a semi-autonomous, or a manual manner. Work site 100 may be a portion of a mining site, a landfill, a quarry, a construction site, or any other area in which movement of material is desired. Tasks associated with moving material may include a dozing operation, a grading operation, a leveling operation, a bulk material removal operation, or any other type of operation that results in the alteration of the existing topography at work site 100. As depicted, work site 100 includes a work area 101 having a high wall 102 at one end and a crest 103 such as an edge of a ridge, embankment, or other change in elevation at an opposite end. Material is moved generally from the high wall 102 towards the crest 103. The work surface 104 of the work area 101 may take any form and refers to the actual profile or position of the terrain of the work area.

As used herein, a machine 10 operating in an autonomous manner operates automatically based upon information received from various sensors without the need for human operator input. As an example, a haul or load truck that automatically follows a path from one location to another and dumps a load at an end point may be operating autonomously. A machine operating semi-autonomously includes an operator, either within the machine or remotely, who performs some tasks or provides some input and other tasks are performed automatically and may be based upon information received from various sensors. As an example, a load truck that automatically follows a path from one location to another but relies upon an operator command to dump a load may be operating semi-autonomously. In another example of a semi-autonomous operation, an operator may dump a bucket of an excavator in a load truck and a controller may automatically return the bucket to a position to perform another digging operation. A machine being operated manually is one in which an operator is controlling all or essentially all of the functions of the machine. A machine may be operated remotely by an operator (i.e., remote control) in either a manual or semi-autonomous manner.

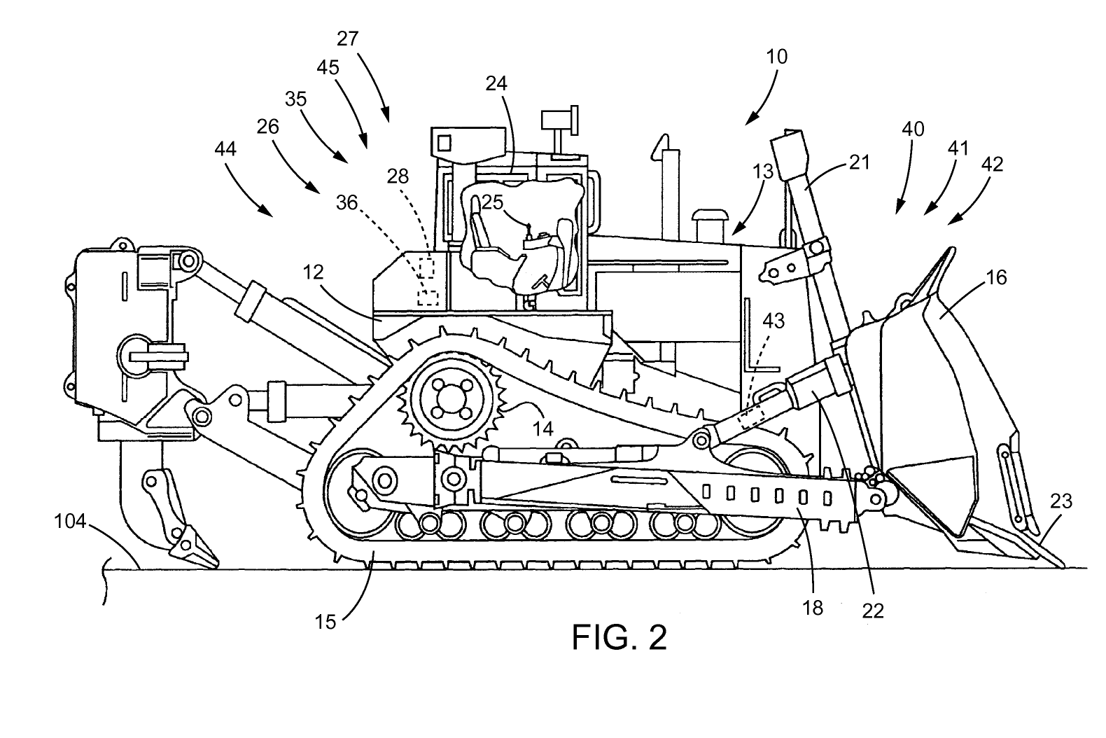

FIG. 2 depicts a diagrammatic illustration of a machine 10 such as a dozer with a ground engaging work implement such as a blade 16 configured to push material. The machine 10 includes a frame 12 and a prime mover such as an engine 13. A ground-engaging drive mechanism such as a track 15 may be driven by a drive sprocket 14 on opposite sides of machine 10 to propel the machine. Although machine 10 is shown in a “track-type” configuration, other configurations, such as a wheeled configuration, may be used. Operation of the engine 13 and a transmission (not shown), which are operatively connected to the drive sprockets 14 and tracks 15, may be controlled by a control system 35 including a controller 36. The systems and methods of the disclosure may be used with any machine propulsion and drivetrain mechanisms applicable in the art for causing movement of the machine including hydrostatic, electric, or mechanical drives.

Blade 16 may be pivotally connected to frame 12 by arms 18 on each side of machine 10. First hydraulic cylinder 21 coupled to frame 12 supports blade 16 in the vertical direction and allows blade 16 to move up or down vertically from the point of view of FIG. 2. Second hydraulic cylinders 22 on each side of machine 10 allow the pitch angle of blade tip 23 to change relative to a centerline of the machine.

Machine 10 may include a cab 24 that an operator may physically occupy and provide input to control the machine. Cab 24 may include one or more input devices such as joystick 25 through which the operator may issue commands to control the propulsion system and steering system of the machine as well as operate various implements associated with the machine.

Machine 10 may be controlled by a control system 35 as shown generally by an arrow in FIG. 2 indicating association with the machine 10. The control system 35 may include an electronic control module or controller 36 and a plurality of sensors. The controller 36 may receive input signals from an operator operating the machine 10 from within cab 24 or off-board the machine through a wireless communications system 130 (FIG. 1). The controller 36 may control the operation of various aspects of the machine 10 including the drivetrain and the hydraulic systems.

The controller 36 may be an electronic controller that operates in a logical fashion to perform operations, execute control algorithms, store and retrieve data and other desired operations. The controller 36 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller 36 such as power supply circuitry, signal conditioning circuitry, driver circuitry, and other types of circuitry.

The controller 36 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the controller 36 may be implemented in hardware and/or software without regard to the functionality. The controller 36 may rely on one or more data maps relating to the operating conditions and the operating environment of the machine 10 and the work site 100 that may be stored in the memory of controller. Each of these data maps may include a collection of data in the form of tables, graphs, and/or equations.

The control system 35 and the controller 36 may be located on the machine 10 and may also include components located remotely from the machine such as at a command center 131 (FIG. 1). The functionality of control system 35 may be distributed so that certain functions are performed at machine 10 and other functions are performed remotely. In such case, the control system 35 may include a communications system such as wireless communications system 130 for transmitting signals between the machine 10 and a system located remote from the machine.

Machine 10 may be configured to be operated autonomously, semi-autonomously, or manually. When operating semi-autonomously or manually, the machine 10 may be operated by remote control and/or by an operator physically located within the cab 24.

Machine 10 may be equipped with a plurality of machine sensors 26, as shown generally by an arrow in FIG. 2 indicating association with the machine 10, that provide data indicative (directly or indirectly) of various operating parameters of the machine and/or the operating environment in which the machine is operating. The term “sensor” is meant to be used in its broadest sense to include one or more sensors and related components that may be associated with the machine 10 and that may cooperate to sense various functions, operations, and operating characteristics of the machine and/or aspects of the environment in which the machine is operating.

A position sensing system 27, as shown generally by an arrow in FIG. 2 indicating association with the machine 10, may include a position sensor 28, also shown generally by an arrow in FIG. 2 to indicate association with the machine, to sense the position and orientation (i.e., the heading, pitch, roll or tilt, and yaw) of the machine relative to the work site 100. The position and orientation of the machine 10 are sometimes collectively referred to as the position of the machine. The position sensor 28 may include a plurality of individual sensors that cooperate to generate and provide position signals to controller 36 indicative of the position and orientation of the machine 10. In one example, the position sensor 28 may include one or more sensors that interact with a positioning system such as a global navigation satellite system or a global positioning system to operate as a position sensor. In another example, the position sensor 28 may further include a slope or inclination sensor such as pitch angle sensor for measuring the slope or inclination of the machine 10 relative to a ground or earth reference. The controller 36 may use position signals from the position sensors 28 to determine the position of the machine 10 within work site 100. In other examples, the position sensor 28 may include an odometer or another wheel rotation sensing sensor, a perception based system, or may use other systems such as lasers, sonar, or radar to determine all or some aspects of the position of machine 10.

In some embodiments, the position sensing system 27 may include a separate orientation sensing system. In other words, a position sensing system may be provided for determining the position of the machine 10 and a separate orientation sensing system may be provided for determining the orientation of the machine.

If desired, the position sensing system 27 may also be used to determine a ground speed of machine 10. Other sensors or a dedicated ground speed sensor may alternatively be used to determine the ground speed of the machine 10.

Machine 10 may be configured to move material at the work site 100 according to one or more material movement plans from an initial location 107 to a spread or dump location 108. The dump location 108 may be at crest 103 or at any other location. The material movement plans may include, among other things, forming a plurality of spaced apart channels or slots 110 that are cut into the work surface 104 at work site 100 along a path from the initial location 107 to the dump location 108. In doing so, each machine 10 may move back and forth along a linear path between the initial location 107 and the dump location 108. If desired, a relatively small amount of material may be left or built up as walls 111 between adjacent slots 110 to prevent or reduce spillage and increase the efficiency of the material moving process. The walls 111 between the slots 110 may be moved after the slots are formed or periodically as desired. The process of moving material through slots 110 while utilizing walls 111 of material to increase the efficiency of the process is sometime referred to as “slot dozing.”

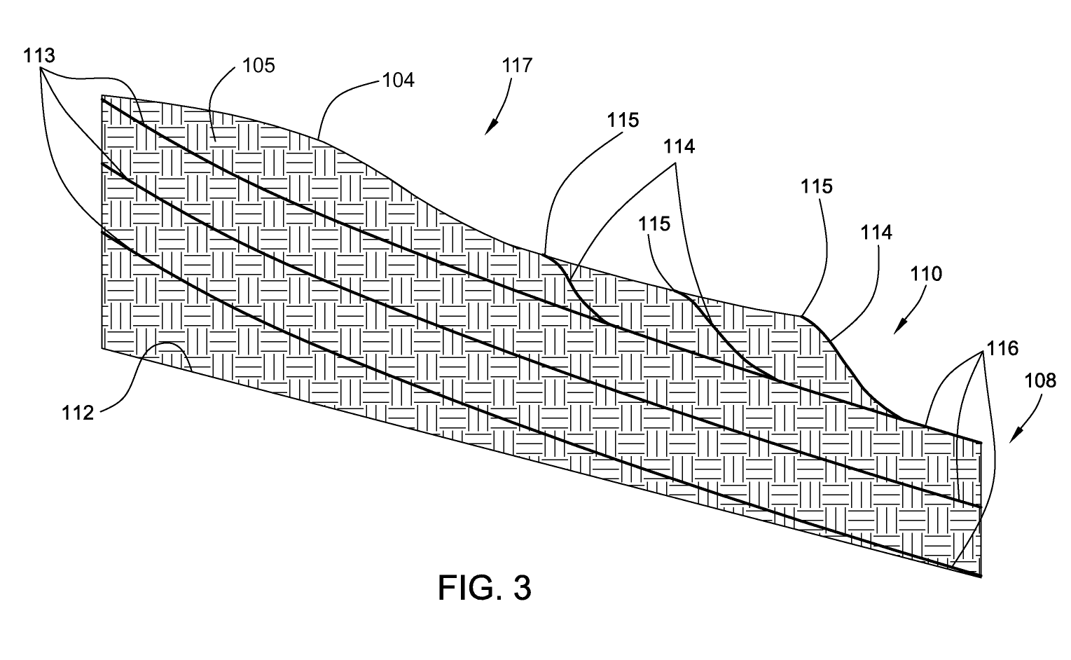

As depicted in FIG. 3, in one embodiment, each slot 110 may be formed by removing material 105 from the work surface 104 in one or more layers or passes 113 until the final work surface or final design plane 112 is reached. The blade 16 of machine 10 may engage the work surface 104 with a series of cuts 114 that are spaced apart lengthwise along the slot 110. Each cut 114 begins at a cut location 115 along the work surface 104 at which the blade 16 engages the work surface and extends into the material 105 and moves towards the pass target or carry surface 116 for a particular pass. Controller 36 may be configured to guide the blade 16 along each cut 114 until reaching the carry surface 116 and then follow the carry surface towards the dump location 108.

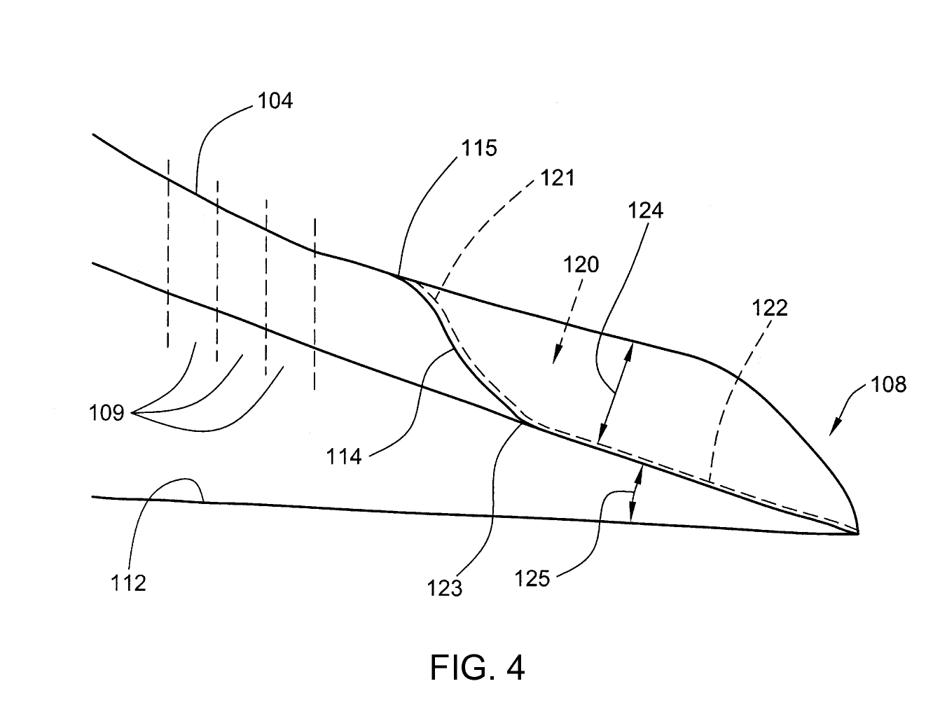

During each material moving pass, the controller 36 may guide the blade 16 generally along a desired path or target profile depicted by dashed line 120 in FIG. 4 from the cut location 115 to the dump location 108. A first portion of the target profile 120 extends from the cut location 115 to the carry surface 116. The first portion may be referred to as the loading profile 121 as that is the portion of the target profile 120 at which the blade 16 is initially loaded with material. A second portion of the target profile 120 extends from the intersection 123 of the cut 114 and the carry surface 116 to the dump location 108. The second portion may be referred to as the carry profile 122 as that is the portion of the target profile 120 at which the blade 16 carries the load along the carry surface 116.

The first portion or loading profile 121 may have any configuration and, depending on various factors including the configuration of the work surface 104 and the type of material to be moved, some cut profiles may be more efficient than others. The loading profile 121 may be formed of one or more segments that are equal or unequal in length and with each having different or identical shapes. These shapes may be linear, symmetrically or asymmetrically curved, Gaussian-shaped or any other desired shape. In addition, the angle of any of the shapes relative to the work surface 104 or the final design plane 112 may change from segment to segment.

The second portion or carry profile 122 may have any configuration but is often generally linear and sloped downward so that movement of material will be assisted by gravity to increase the efficiency of the material moving process. In other words, the carry profile 122 is often configured so that it slopes downward towards the dump location 108. The characteristics of the carry profile 122 (sometimes referred to as the slot parameters) may define the shape of the carry surface 116, the depth of the carry surface 116 below an uppermost surface of the work surface 104 as indicated by reference number 124, and the angle of the carry surface as indicated by reference number 125. In some instances, the angle 125 of the carry surface 116 may be defined relative to a gravity reference or relative to the final design plane 112.

Although it may be generally desirable for the blade 16 to follow the target profile 120, performance characteristics of the machine 10, characteristics of the material 105, and/or desired operating efficiencies may cause a deviation from the target profile 120. More specifically, as blade 16 makes a cut 114, the load on the blade will increase. Further, as the blade 16 travels along the carry surface 116, the load on the blade may continue to increase. If the blade 16 is overloaded for a particular slope, the machine 10 may slip and/or cause excess wear on the machine. Accordingly, the target profile 120 may define the lower boundary of movement of blade 16. In one example, the control system 35 may include a blade control system 40 to improve the efficiency of the material moving process.

In one embodiment, the blade control system 40 may control the load on the blade 16 so that the torque generated by the machine 10 is generally maintained at or about a predetermined value. In one example, it may be desirable to maintain the load on the machine 10 at approximately 80% of its maximum torque. In other examples, it may be desirable to maintain the load within a range of approximately 70-90% of the maximum torque. Other values and ranges are contemplated. In order to maintain the load at a desired value or within a desired range, the blade control system 40 may raise or lower the blade 16 to decrease or increase the amount of material carried by the blade 16 and thus decrease or increase the load.

The control system 35 may include an implement load monitoring system 41 shown generally by an arrow in FIG. 2. The implement load monitoring system 41 may include a variety of different types of implement load sensors depicted generally by an arrow in FIG. 2 as an implement load sensor system 42 to measure the load on the blade 16. In one embodiment, the implement load sensor system 42 may embody one or more pressure sensors 43 for use with one or more hydraulic cylinder, such as second hydraulic cylinders 22, associated with blade 16. Signals from the pressure sensor 43 indicative of the pressure within the second hydraulic cylinders 22 may be monitored by controller 36. Other manners of determining a change in cylinder pressure associated with a change in the load on blade 16 are contemplated, including other manners of measuring the pressure within second hydraulic cylinders 22 and measuring the pressure within other cylinders associated with the blade. The load on the blade 16 may be correlated to the load on the engine 13 by controller 36.

The load on the blade 16 may be affected by the slope of the terrain upon which the machine 10 is moving. Accordingly, if desired, the accuracy of the implement load measurement may be increased by utilizing the implement load sensor system 42 in conjunction with a slope or inclination sensor such as a pitch angle sensor. For example, if the machine 10 is moving uphill, the load on the blade 16 may be higher due to gravity as compared to a machine operating in the same conditions on flat terrain. Similarly, the load on the blade 16 may be lower for the same mass or volume when the machine in moving downhill. By determining the slope of the terrain, the controller 36 may more accurately determine changes in the load on the blade 16.

If desired, control system 35 may also include a machine load monitoring system 44 that may be used by the blade control system 40. In one embodiment, the machine load monitoring system 44 may utilize an engine speed sensor (not shown) and a torque converter speed sensor (not shown) to measure a difference between the speed of the engine 13 and a torque converter (not shown) to determine the load on the machine 10.

Control system 35 may include a module or planning system 45 for determining or planning various aspects of the excavation plan. The planning system 45 may receive and store various types of input such as the configuration of the work surface 104, the final design plane 112, a desired loading profile 121, a desired carry profile 122, and characteristics of the material to be moved. Operating characteristics and capabilities of the machine 10 such as maximum load may also be entered into the planning system 45 as additional inputs. The planning system 45 may simulate the results of cutting the work surface 104 at a particular cut location based upon any of the plurality of inputs and then choose a cut location that creates the most desirable results based on one or more criteria. In one embodiment, the planning function may be performed while operating the machine 10. In another embodiment, some or all aspects of the planning function may be performed ahead of time and the various inputs to the planning system 45 and the resultant cut locations, target profiles, and related data stored as part of the data maps of the controller 36.

Referring to FIGS. 3 and 4, a potential cut 114 at work site 100 that may be generated by control system 35 is illustrated. Work surface 104 represents the uppermost height of the existing material 105 at the slot 110. While the illustration is depicted in two dimensions, it should be appreciated that the data representing the illustration may be in three dimensions. In one example, the path 117 along slot 110 may be divided into a plurality of increments 109 (FIG. 4) and data stored within controller 36 for each increment. The controller 36 may store information or characteristics of the increment 109 such as the length of the work surface and its angular orientation relative to a ground reference, the material characteristics of the material 105 beneath the work surface, a time stamp or indicator of the age of the data, and any other desired information. The information regarding each path 117 may be stored within an electronic map within controller 36 as part of a topographical map of the work site 100.

Information regarding each path 117 may be obtained according to any desired method. In one example, the machine 10 may utilize the position sensing system 27 described above to map out the contour of work surface 104 as machine 10 moves across it. This data may also be obtained according to other methods such as by a vehicle that includes lasers and/or cameras. It should be noted that as the machine 10 moves material 105 to the dump location 108, the position of the work surface 104 will change and may be updated based upon the current position of the machine 10 and the position of the blade 16.

As may be seen in FIG. 4, moving the blade 16 along the target profile 120 will result in a volume of material 105 being moved from slot 110. The planning system 45 may use the shape of the loading profile 121 and the cut location 115 to determine the volume of material that would be moved by blade 16 if the machine 10 were to follow the target profile 120. More specifically, the planning system 45 may use three-dimensional data that is used to represent the machine 10, the work surface 104, and the target profile 120 to make a volumetric calculation of the volume of material that will be moved for a particular target profile 120.

Planning system 45 may be configured to determine a cut location in any of a plurality of manners. In some embodiments, the planning system 45 may analyze a plurality of potential cut locations beginning with a cut location generally near the crest 103 and move potential cut locations uphill or towards the high wall 102 until desired parameters for a cut location are met and an initial cut location selected. In one example, the desired parameter may be the volume of material being moved reaching a desired threshold such as 80% of the maximum capacity of the machine 10.

As used herein, the word “uphill” refers to a direction towards the high wall 102 relative to the crest 103 or dump location 108. Similarly, the word “downhill” refers to a direction towards the crest 103 or dump location 108 relative to the high wall 102.

In order to increase the efficiency of the material moving process, planning system 45 may be configured to analyze additional potential cut locations to determine whether any of the additional potential cut locations will permit loading of the blade 16 to the desired level or percentage within a shorter distance. In one example, the loading of the blade 16 may be analyzed in terms of volume as a percentage of the maximum load of the machine 10 or the blade. The loading may, however, be expressed in any other desired manner. By loading the blade 16 in a shorter distance, the blade 16 will be fully loaded for a greater percentage of the time or distance that the machine 10 is moving towards the dump location 108. In addition, in some instances, a machine 10 may have difficulty in efficiently carrying out certain types of cutting operations (e.g., cuts that are spaced apart along the work surface) and therefore the machine may be more likely to be able to follow a desired cutting profile of a cutting operation that occurs over a shorter distance.

Accordingly, the planning system 45 may be configured to determine a plurality of potential cut locations along the path 117 and then determine a volume of material to be moved for each of the potential cut locations. The volume of material to be moved may be determined based upon the loading profile, a relatively short evaluation cut length, and the position of the work surface for each potential cut location. The planning system 45 may select an optimized cut location from one of the plurality of potential cut locations for which the volume of material exceeds a material volume threshold. The planning system 45 may then replace the initial cut location with the optimized cut location and begin the cutting process.

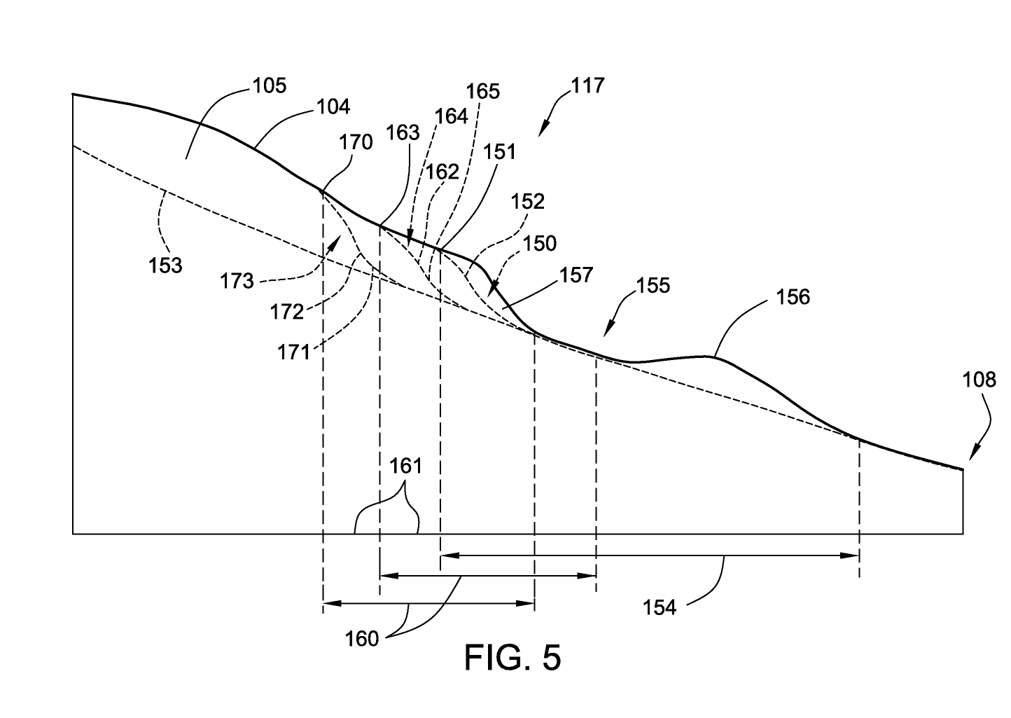

Referring to FIG. 5, a cross section of a portion of the work site 100 is depicted with an initial target profile 150 that begins at an initial cut location 151 along work surface 104 and extends along a Gaussian-shaped initial loading profile 152 and finally leads to and intersects with carry surface 153. Based upon the initial target profile 150, the planning system 45 evaluates the volume of material to be moved along the initial cut length 154 during the cut defined by the initial loading profile. In doing so, the planning system 45 may determine the volume of material 105 above the proposed path of the tip 23 of blade 16 (i.e., the material between the initial target profile 150 and work surface 104) that would be moved towards the dump location 108 by the proposed cut.

As may be seen in FIG. 5, the work surface 104 has a recess or valley 155 slightly downhill from the initial cut location 151 and then has a mound or hill 156 that tapers downhill towards the carry surface 153. The volume of material to be moved according to the initial target profile 150 includes the portion 157 of the material above the initial target profile 150 together with the entire hill 156. In one embodiment, when analyzing the initial cut location 151, the planning system 45 may analyze the volume of material moved above the initial target profile 150 (e.g., hill 156 and portion 157) and determine whether the combined volume meets a material volume threshold stored within the controller 36.

In one embodiment, the planning system 45 may be configured to analyze whether cuts at any of a plurality of potential cut locations along path 117 will meet the material volume threshold when using a shorter target profile. Using a shorter target profile will result in an evaluation cut length 160 that is shorter than the initial cut length 154. A shorter target profile may also result in a steeper or more aggressive loading profile as compared to that of a longer target profile. The planning system 45 may define the plurality of potential cut locations by dividing path 117 into a plurality of analysis increments 161. The analysis increments may be any length and, in one embodiment, may be set to equal one or more lengths of the increments 109 (FIG. 4) used for mapping the work site 100 as described above.

In some instances, the planning system 45 may operate by selecting the initial cut location 151 at the location farthest downhill that meets the material volume threshold. Accordingly, the analysis of additional potential cut locations may often move sequentially uphill from the initial cut location. If the planning system 45 utilizes other manners of determining the initial cut location, it may be desirable to also analyze potential cut locations located downhill from the initial cut location 151.

As depicted in FIG. 5, a first target profile 162 begins at a first potential cut location 163 located one analysis increment 161 uphill from the initial cut location 151. The first potential cut 164 has a generally Gaussian-shaped first loading profile 165 that leads to and intersects with carry surface 153.

The planning system 45 may then determine the second potential cut location 170 for the next uphill analysis increment 161 by starting at the first potential cut location 163 and moving uphill by the length of one analysis increment. The second target profile 171 begins at second potential cut location 170 and has a generally Gaussian-shaped second loading profile 172 that leads to and intersects with carry surface 153. The process of defining additional potential cut locations may be repeated to establish or determine a desired number of analysis increments 161. An additional target profile may begin at each additional potential cut location.

The planning system 45 may analyze each target profile to determine the volume of material to be moved over the evaluation cut length 160 and compare the volume to the material volume threshold. If the volume to be moved exceeds the material volume threshold, the planning system 45 may select that potential cut location as the optimized cut location. If the volume does not exceed the material volume threshold, the planning system 45 may repeat the analysis for additional potential cut locations. If desired, the planning system 45 may be configured to sequentially determine the volume of material to be moved for each of the potential cut locations along the path 117.

More specifically, path 117 may include a path start location and a path end location and the plurality of potential cut locations are located between the path start location and the path end location. During a dozing pass or cut, material 105 is generally moved along the path 117 in a direction from the path start location to or towards the path end location. The planning system 45 may be configured to determine the volume of material to be moved beginning at the potential cut location closest to the initial cut location 151 and then evaluate the potential cut locations sequentially towards the path start location until the volume of material for one of the potential cut locations exceeds the material volume threshold. In such case, the first potential cut location that meets the material volume threshold would be set as or define the optimized cut location.

As an example, referring to FIG. 5, the planning system 45 may analyze a cut at the first potential cut location 163 based upon the first target profile 162 and the position of work surface 104. The planning system may determine the volume of material to be moved along the evaluation cut length 160 based upon a cut defined by the first target profile 162 beginning at the first potential cut location 163. In other words, the planning system may compare the volume of material 105 to be moved to the material volume threshold stored in controller 36.

As depicted in FIG. 5, the volume of material to be moved by at cut beginning a the first potential cut location 163 and following the first target profile 162 does not meet the material volume threshold. Accordingly, the planning system 45 may determine the position of the second potential cut location 170 as described above and determine the volume of material moved based upon a second potential cut 173 defined by the second target profile 171 beginning at the second potential cut location 170. The planning system may compare the volume of material 105 to be moved by the second potential cut 173 to the material volume threshold stored in controller 36.

As depicted in FIG. 5, the volume of material 105 to be moved by the second potential cut 173 meets the material volume threshold and the second potential cut location 170 may be set as the optimized cut location and a command may be generated by controller 36 to begin a cutting operation at the optimized cut location. If, however, the volume of material 105 to be moved did not meet the material volume threshold, the analysis process could be repeated for additional potential cut locations until locating a potential cut location that meets the material volume threshold or until the planning system 45 terminates the analysis. In one non-limiting example, the planning system 45 may terminate the analysis and begin a cutting operating at the initial cut location 151 after analyzing a predetermined number of potential cut locations or after moving a predetermined distance uphill past the initial cut location.

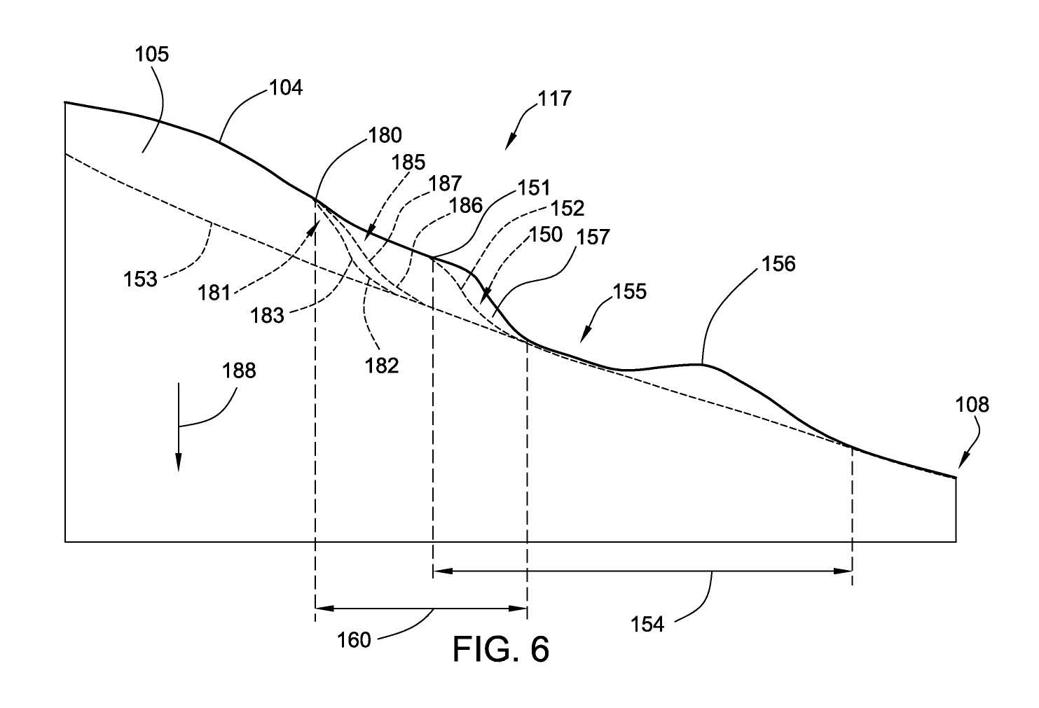

In another embodiment, the planning system 45 may be configured to analyze cuts at a plurality of potential cut locations along path 117 by analyzing a plurality of loading profiles and determining whether any of the volumes of material to be moved for each of the plurality of loading profiles at each potential cut location will meet the material volume threshold. In an example depicted in FIG. 6, two potential cuts are depicted at potential cut location 180. A first potential cut 181 includes a first target profile 182 having a generally Gaussian-shaped first loading profile 183 that leads to and intersects with carry surface 153. A second potential cut 185 includes a second target profile 186 having a generally Gaussian-shaped second loading profile 187 that leads to and intersects with carry surface 153. As depicted in FIG. 6, the first loading profile is generally steeper relative to a gravity reference 188 than the second loading profile.

The planning system 45 may be configured to determine the volume of material to be moved at each of the plurality of potential cut locations using both the first loading profile 183 and the second loading profile 187. More specifically, the planning system may perform two analyses at each potential cut location. The first analysis may use the first target profile 182 (and thus the first loading profile 183) and the second analysis may use the second target profile 186 (and thus the second loading profile 187). As part of each analysis, the planning system 45 may determine the volume of material to be moved based upon the respective target profile and the position of the work surface 104 and compare the volume to the material volume threshold.

If none of the target profiles meets the material volume threshold at a potential cut location, the analysis may be performed at additional potential cut locations as described above. If only one of the target profiles meets the material volume threshold at a potential cut location, the optimized cut location may be set to the potential cut location being analyzed and the target profile meeting the material volume threshold may be used as the desired path to carry out the cut. If both of the target profiles meet the material volume threshold at a potential cut location, the planning system may be configured to set the potential cut location as the optimized cut location and select the target profile with the steeper of the two loading profiles as the desired path to carry out the cut.

In the example depicted in FIG. 6, if the material volume for each of the first loading profile 183 and the second loading profile 187 exceeds the material volume threshold, the planning system 45 may select the first loading profile as that loading profile is steeper than the second loading profile. Although depicted with two loading profiles, any number of loading profiles may be analyzed at each potential cut location.

It should be noted that the planning system 45 may be configured not to use or consider loading profiles that will result in an extremely steep cut surface. More specifically, while it may be generally desirable for the machine 10 to maximize the steepness or aggressiveness of the cuts, a relatively steep cut may result in a cut surface that machine 10 may only be able to climb in first gear. Operation of the machine 10 in first gear as it backs up to perform additional cuts will result in slower movement and increased fuel costs. Accordingly, the planning system 45 may be configured to limit the steepness of loading profiles to those that will result in a cut surface that the machine 10 may climb in second gear.

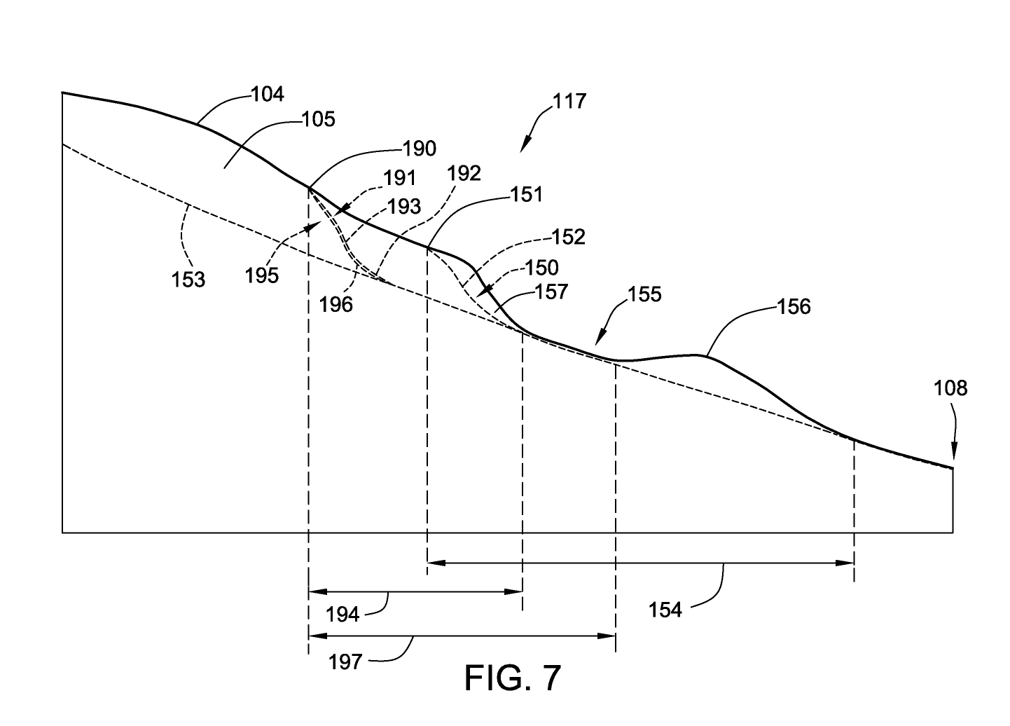

In still another embodiment, the planning system 45 may be configured to analyze cuts at a plurality of potential cut locations along path 117 by analyzing a plurality of evaluation cut lengths and determining whether any of the volumes of material to be moved for each of the plurality of evaluation cut lengths at each potential cut location will meet the material volume threshold. In an example depicted in FIG. 7, two potential cuts are depicted at potential cut location 190. A first potential cut 191 includes a first target profile 192 having a generally Gaussian-shaped first loading profile 193 that leads to and intersects with carry surface 153. The first evaluation cut length is indicated at 194. A second potential cut 195 includes a second target profile 196 but has the same generally Gaussian-shaped first loading profile 193 that leads to and intersects with carry surface 153. The second potential cut 195 differs from the first potential cut in that it has a second, longer evaluation cut length indicated at 197. Thus, the second target profile 196 is longer than the first target profile 192. Both the first evaluation cut length and the second evaluation cut length 197 are shorter than the initial cut length 154.

The planning system 45 may be configured to determine the volume of material to be moved at each of the plurality of potential cut locations using both the first target profile 192 and the second target profile 196. More specifically, the planning system may perform two analyses at each potential cut location. The first analysis may use the first target profile 192 (and thus the first evaluation cut length 194) and the second analysis may use the second target profile 196 (and thus the second evaluation cut length 197). As part of each analysis, the planning system 45 may determine the volume of material to be moved based upon the respective target profile and the position of the work surface 104 and compare the volume to the material volume threshold.

If none of the target profiles meets the material volume threshold at a potential cut location, the analysis may be performed at additional potential cut locations as described above. If only one of the target profiles meets the material volume threshold at a potential cut location, the optimized cut location may be set to the potential cut location being analyzed and the target profile meeting the material volume threshold may be used as the desired path to carry out the cut. If both of the target profiles meet the material volume threshold at a potential cut location, the planning system may be configured to set the potential cut location as the optimized cut location and select the target profile with the shorter of the two evaluation cut lengths as the desired path to carry out the cut.

In the example depicted in FIG. 7, if the material volume for each of the first potential cut 191 and the second potential cut 195 each exceeds the material volume threshold, the planning system 45 may select the first potential cut as that cut has a shorter evaluation cut length than that of the second potential cut 195. Although depicted with two evaluation cut lengths, any number of evaluation cut lengths may be analyzed at each potential cut location.

In some instances, it may be desirable for the planning system 45 to perform the analysis process while the machine is moving uphill from the dump location 108 after completing a cutting pass. In doing so, the planning system 45 may operate to select the optimized cut location while the machine 10 is moving uphill along the path 117. It may be desirable for the controller 36 to move the machine 10 uphill only until it reaches the optimized cut location and then send appropriate commands to begin a new cutting pass or operation. Moving the machine 10 farther uphill than the optimized cut location may be inefficient as it will result in wasted fuel and time as the machine is subsequently moved downhill in an unloaded condition to the optimized cut location. Further, maintaining the machine 10 at the dump location 108 during the analysis process may also be inefficient as it may increase the cycle time for the cutting passes and increase fuel usage while idling. By controlling the speed of the machine 10 during the analysis process, fuel usage and time may also be optimized.

In order to further reduce the time required for signals to be transmitted from a remote location to the machine 10, it may be desirable for a portion of the controller 36 on-board the machine to be able to perform some, if not all, of the cut location analysis. For example, it may be desirable for an on-board portion of the controller 36 to determine the position of the plurality of potential cut locations along the path, determine the volume of material to be moved for each of the plurality of potential cut locations, and select the optimized cut location. By providing that at least a portion of the cut location analysis occurs on-board machine 10, delays in signal transmission from a portion of the controller 36 remote from machine 10 may be reduced or eliminated.

Although described in the context of evaluating volume, the planning system 45 may also analyze cut locations with respect to other criteria in addition to volume such as the suitability of the terrain profile or work surface 104 near a cut location, material properties at or near the cut location, and characteristics of digging action of the machine such as cut depth.

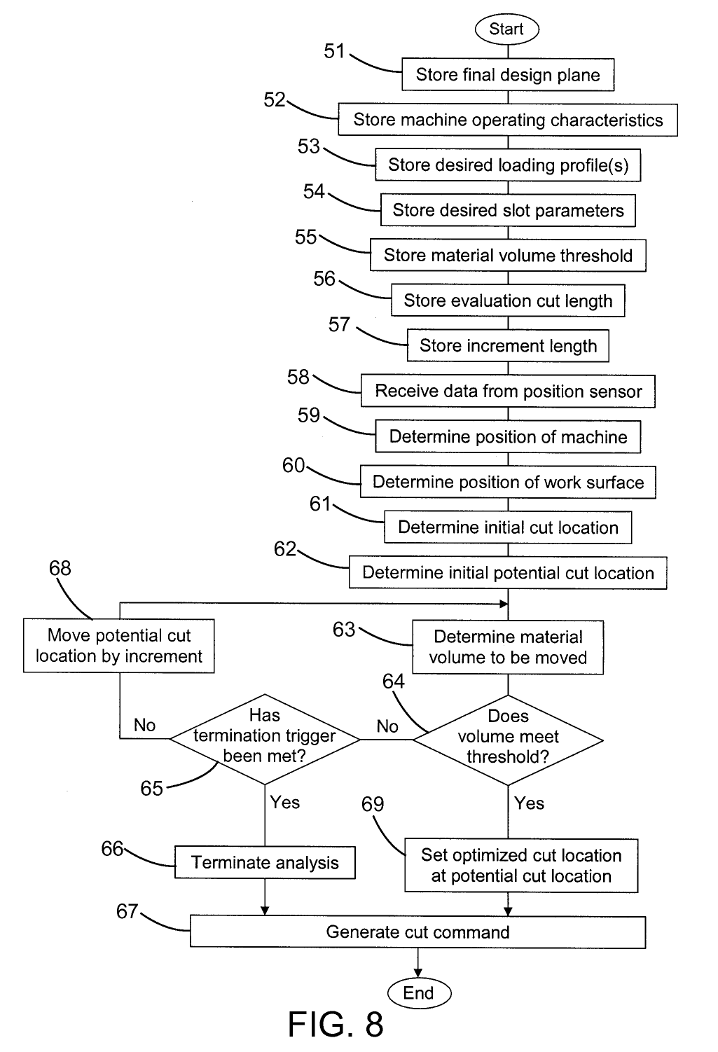

The flowchart in FIG. 8 depicts a process in which the planning system 45 may determine an optimal location for a cut 114 by utilizing a sequential process to analyze potential cut locations uphill from an initial cut location 151. At stage 51, the final design plane 112 may be set or stored within or entered into the controller 36. In one embodiment, the final design plane 112 may be entered by an operator or other personnel. In another embodiment, the final design plane 112 may be generated by the controller 36.

At stage 52, the operating characteristics of the machine 10 may be entered into controller 36. The operating characteristics may include a desired maximum load on the machine 10 and the dimensions of the machine including those of blade 16. The dimensions of blade 16 may be used by controller 36 to determine the volume of material that may be moved by the machine 10.

The desired loading profile 121 of the target profile 120 may be entered into the controller 36 at stage 53. As stated above, the loading profile 121 may have any desired configuration. At stage 54, the carry profile 122 or slot parameters may be entered into the controller 36. The slot parameters may define the shape of the carry surface 116, the depth of carry surface below the work surface 104 and each subsequent carry surface, the angle 125 of the carry surface 116 relative to a fixed reference, and the curvature of the carry surface. The initial cut length 154 may be determined from the loading profile 121 and the carry profile 122.

At stage 55, a material volume threshold may be set or stored within the controller 36. The material volume threshold may set the minimum required volume to be carried by the blade 16 for a potential cut location.

The length of an analysis increment 161 may be set or stored at stage 56. As stated above, the analysis increments 161 may be equal to the length of one or more of the increments 109 used for mapping the work site 100 or any other length. The evaluation cut length 160 may be set or stored at stage 57. The evaluation cut length 160 may be set to any desired length that is shorter than the initial cut length 154.

The controller 36 may receive at stage 58 data from the position sensor 28. At stage 59, the controller 36 may determine the position of the machine 10 based upon the data from the position sensor 28.

The position or configuration of the work surface 104 may be determined at stage 60. The configuration of the work surface 104 may be determined in any desired manner including moving machines autonomously about the work site 100. In an alternate process, an operator may manually operate machines 10, either from within the cab 24 of the machine or by remote control, and the topography of the work site 100 recorded. In another alternate embodiment, an electronic map of the work site may be generated by moving a mapping vehicle (not shown) about the work site. As the machine 10 moves along the path 117, the position of the machine may be used to determine the position of the work surface and update the electronic map of the work site 100 within controller 36.

The initial cut location 151 may be set or determined at stage 61 in any manner as described in more detail above. The first potential cut location 163 may be determined at stage 62 by controller 36. In one embodiment, the first potential cut location 163 may be determined by starting at the initial cut location 151 and moving uphill (e.g., towards high wall 102) a distance equal to one analysis increment 161. The controller 36 may determine at stage 63 the volume of material moved by a cut beginning at the first potential cut location 163 and moving along the first target profile 162.

At decision stage 64, the controller 36 may determine whether the calculated volume for the first potential cut location 163 exceeds the material volume threshold. If the volume for the first potential cut location 163 does not exceed the material volume threshold, the controller 36 may determine at decision stage 65 whether a termination trigger has been reached. For example, the planning system 45 may terminate the analysis after analyzing a predetermined number of potential cut locations or after the potential cut locations have been moved a predetermined distance uphill past the initial cut location. If a termination trigger has been reached at decision stage 65, the planning system 45 may be configured to terminate at stage 66 the search for an optimized cut location. In addition, if desired, controller 36 may generate an alert command to notify the operator that the analysis has been terminated. The controller 36 may generate at stage 67 a cut command using the initial cut location 151.

If a termination trigger has not been reached at decision stage 65, the controller 36 may continue the analysis at stage 68 by moving the potential cut location uphill by the length of one analysis increment 161 from the first potential cut location 163. The process of stages 63-65 and 68 may be repeated to analyze the second potential cut location 170 and each subsequent potential cut location until the volume of one of the potential cut locations exceeds the material volume threshold at decision stage 64 or the process is terminated at decision stage 65.

Once the volume exceeds the material volume threshold at decision stage 64, the controller 36 may terminate the analysis process and set at stage 69 the current potential cut location as the location for the optimized cut location. The controller 36 may generate appropriate commands at stage 67 to direct the machine 10 to cut the work surface 104 at the optimized cut location.

### INDUSTRIAL APPLICABILITY

The industrial applicability of the control system 35 described herein will be readily appreciated from the forgoing discussion. The foregoing discussion is applicable to systems in which a plurality of machines 10 are operated autonomously, semi-autonomously, or manually at a work site 100. Such system may be used at a mining site, a landfill, a quarry, a construction site, a roadwork site, a forest, a farm, or any other area in which movement of material is desired.

Machine 10 may be operative with a planning system 45 of control system 35 and operate to determine an initial location for a cut 114. The initial cut location 151 may be determined in any of a variety of manners. The planning system 45 may further be operative to analyze a plurality of additional potential cut locations to determine whether any of the additional potential cuts will result in fully loading the blade 16 over a shorter distance as compared to the initial cut location 151. To do so may increase the efficiency of the material moving process and reduce the likelihood that the planning system will direct the blade 16 along a path that may be difficult for it to follow.

In some instances, it may be desirable for the planning system 45 to determine the initial cut location 151 and analyze the potential cut locations while the machine 10 is moving uphill after completing a cutting pass. By synchronizing the determination of the optimized cut location with the movement of the machine 10 uphill towards the high wall 102, it may be possible to improve the efficiency of the operation of the machine. For example, fuel and time will not be wasted while idling during the analysis process and the machine will not move farther uphill than is necessary.

It will be appreciated that the foregoing description provides examples of the disclosed system and technique. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A system for determining an optimized cut location for a work implement of a machine, the machine moving on a work surface along a path, comprising:
a position sensor associated with the machine for generating position signals indicative of a position of the work surface;
a controller configured to:
store a loading profile;
store a material volume threshold;
store an evaluation cut length;
receive position signals from the position sensor;
determine the position of the work surface based upon the position signals;
determine an initial cut location along the path based upon an initial target profile, the initial target profile having an initial cut length, the evaluation cut length being shorter than the initial cut length;
determine a plurality of potential cut locations along the path;
determine a volume of material to be moved for each of the plurality of potential cut locations, the volume of material to be moved being based upon the loading profile, the evaluation cut length, and the position of the work surface; and
select the optimized cut location from one of the plurality of potential cut locations for which the volume of material exceeds the material volume threshold.

2. The system of claim 1, wherein the controller is further configured to sequentially determine the volume of material to be moved for each of the plurality of potential cut locations along the path until the volume of material for one of the plurality of potential cut locations exceeds the material volume threshold, the one of the plurality of potential cut locations defining the optimized cut location.

3. The system of claim 2, wherein the path includes a path start location and a path end location and the plurality of potential cut locations are between the path start location and the path end location, and the controller is configured to determine the volume of material to be moved beginning at a potential cut location closest to the initial cut location and evaluate the plurality of potential cut locations sequentially towards the path start location.

4. The system of claim 3, wherein material is generally moved along the path in a direction from the path start location towards the path end location.

5. The system of claim 1, wherein the controller is further configured to determine a loading profile along the path and the volume of material is further based upon a distance between the loading profile and the work surface.

6. The system of claim 1, wherein the controller is further configured to generate a plurality of loading profiles and determine the volume of material to be moved for each of the plurality of loading profiles at each of the plurality of potential cut locations.

7. The system of claim 6, wherein the plurality of loading profiles includes a first loading profile and a second loading profile, and wherein the controller is further configured to determine the volume of material to be moved at each of the plurality of potential cut locations using both the first loading profile and the second loading profile, the first loading profile being generally steeper relative to a gravity reference than the second loading profile.

8. The system of claim 7, wherein the controller is further configured to select the first loading profile if the volume of material for each of the first loading profile and the second loading profile each exceeds the material volume threshold.

9. The system of claim 1, wherein the controller is further configured to store a plurality of evaluation cut lengths and determine the volume of material to be moved based upon each of the plurality of evaluation cut lengths at each of the plurality of potential cut locations.

10. The system of claim 9, wherein the controller is further configured to select a shorter of the evaluation cut lengths at any of the plurality of potential cut locations that exceeds the material volume threshold.

11. The system of claim 1, further including a ground-engaging drive mechanism for moving the machine along the path and wherein the controller is configured to determine the volume of material to be moved for each of the plurality of potential cut locations while the machine is moving along the path.

12. The system of claim 1, wherein a portion of the controller on-board the machine is further configured to determine the initial cut location, determine the plurality of potential cut locations, determine the volume of material to be moved, and select the optimized cut location.

13. A controller-implemented method for determining an optimized cut location for a work implement of a machine, the machine moving on a work surface along a path, comprising:
storing a loading profile;
storing a material volume threshold;
storing an evaluation cut length;
receiving position signals from a position sensor;
determining a position of the work surface based upon the position signals;
determining an initial cut location along the path based upon an initial target profile, the initial target profile having an initial cut length, the evaluation cut length being shorter than the initial cut length;
determining a plurality of potential cut locations along the path;
determining a volume of material to be moved for each of the plurality of potential cut locations, the volume of material to be moved being based upon the loading profile, the evaluation cut length, and the position of the work surface; and
selecting the optimized cut location from one of the plurality of potential cut locations for which the volume of material exceeds the material volume threshold.

14. The method of claim 13, further including sequentially determining the volume of material to be moved for each of the plurality of potential cut locations along the path until the volume of material for one of the plurality of potential cut locations exceeds the material volume threshold, the one of the plurality of potential cut locations defining the optimized cut location.

15. The method of claim 14, wherein the path includes a path start location and a path end location and the plurality of potential cut locations are between the path start location and the path end location, and further including determining the volume of material to be moved beginning at a potential cut location closest to the initial cut location and evaluating the plurality of potential cut locations sequentially towards the path start location.

16. The method of claim 13, further including generating a first loading profile and a second loading profile, the first loading profile being generally steeper relative to a gravity reference than the second loading profile, and determining the volume of material to be moved for the first loading profile and the second loading profile at each of the plurality of potential cut locations.

17. The method of claim 13, further including storing a plurality of evaluation cut lengths and determining the volume of material to be moved based upon each of the plurality of evaluation cut lengths at each of the plurality of potential cut locations.

18. The method of claim 13, further including a ground-engaging drive mechanism for moving the machine along the path and further including determining the volume of material to be moved for each of the plurality of potential cut locations while the machine is moving along the path.

19. The method of claim 13, wherein the steps of determining the initial cut location, determining the plurality of potential cut locations, determining the volume of material to be moved, and selecting the optimized cut location all occur on-board the machine.

20. A machine, comprising:
a prime mover;
a work implement for engaging a work surface along a path;
a position sensor for generating position signals indicative of a position of the work surface;
a controller configured to:
store a loading profile;
store a material volume threshold;
store an evaluation cut length;
receive position signals from the position sensor;
determine the position of the work surface based upon the position signals;
determine an initial cut location along the path based upon an initial target profile, the initial target profile having an initial cut length, the evaluation cut length being shorter than the initial cut length;
determine a plurality of potential cut locations along the path;
determine a volume of material to be moved for each of the plurality of potential cut locations, the volume of material to be moved being based upon the loading profile, the evaluation cut length, and the position of the work surface; and
select an optimized cut location from one of the plurality of potential cut locations for which the volume of material exceeds the material volume threshold.
